(19) United States
(12) Patent Application Publication
(10) Pub. No.: US 2008/0142304 A1
(43) Pub. Date: Jun. 19, 2008

(54) SYSTEM AND METHOD FOR LUBRICATING A TRANSPORTATION SYSTEM

(76) Inventors: Richard Schutz, Vienna (AT); Gunter Trojek, Moosbrunn (AT); Michael Matheisl, Vosendorf (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 11/957,850

(22) Filed: Dec. 17, 2007

(30) Foreign Application Priority Data
Dec. 18, 2006 (EP) EP 06126312.5

(51) Int. Cl. F16N 27/00; F16N 25/02

(52) U.S. Cl. 184/7.4; 184/36

(57) ABSTRACT

A lubrication system for a transportation system and, in particular for an escalator or a moving walk, has a piston pump for delivering a prescribed quantity of lubricant per work cycle, an arrangement of lubrication points with at least one lubrication point and a branched lubricant pipeline. Each branch of the lubricant pipeline connects the pump in parallel to a lubricating point of the arrangement of lubrication points. Through a valve arrangement each branch of the lubricant pipeline can be selectively and individually blocked or connected to the piston pump.

The present invention relates to a system and a method for lubricating a transportation system, in particular an escalator or a moving walk.

### BACKGROUND OF THE INVENTION

An escalator comprises a plurality of steps that are connected together by one or more circulating step chains. Furthermore, in the transportation area, these steps are vertically offset relative to each other and thereby make vertical transportation possible. A moving walk comprises a plurality of pallets that are joined together by one or more circulating pallet chains for the horizontal transportation of persons and/or light goods. In both transportation systems handrails can be provided that are driven via handrail chains. Step chains or pallet chains and handrail chains respectively can be coupled via one or more drive units, in particular by one or more main drive chains with one or more drive units, in particular sprockets driven by an electric motor. In view of the different loads of people and circulating lengths, the individual chains generally have different dimensions, in particular number of links and size of chain links, and circulating speeds and runoff speeds as dictated by the specific installation.

To reduce the friction that arises during operation between the steps and their guides, as well as in the chains, and therefore to reduce the driving power required and to increase the service life of the transportation system, sliding and/or link areas of the step chains and/or the various other chains should be lubricated at regular intervals with a lubricant that preferably contains lubricating oil and/or friction-reducing additives. To reduce the related service outlay, such lubrication should by performed automatically by a central, compact, and compressed lubricating system that advantageously allows for the central filling of lubricant, central control, and central inspection. However, for example because of the different dimensions and speeds of circulation of the different chains, lubrication requires the delivery of different quantities of lubricant to the lubrication points that are assigned to the different respective chains.

For this purpose DE 198 47 776 A1 proposes a rotating-stroke piston pump with a plurality of pistons that are coupled together, of which each piston communicates with a lubrication point. By changing the control contours of the individual pistons, the quantity of lubricant that they transport can be individually set. Also known from practice according to DE 198 47 776 A1 is a lubricating system incorporating an electromagnetically actuated multi-feeder pump in which at each electronic control impulse a prescribed quantity of lubricant is delivered into lubricant pipelines that are arranged in parallel. A progressive distributor can be added to distribute the volume of lubricant onto the individual pipelines. The delivered volumes of lubricant cannot be individually and precisely set with high reproducibility. This results in underlubrication of the escalator, which causes or triggers rapid wear of the chain.

Mechanical setting of the individual quantities of lubricant that are delivered to the individual lubrication points by changing control contours, as proposed in DE 198 47 776 A1, is complex and allows only a limited accuracy of lubrication and dosing of the quantity of lubricant. It is also, for example, generally not possible to load the individual lubrication points successively or sequentially or in steps, since at all times during operation of the rotating-stroke piston pump, all pistons operate with forced coupling and simultaneously. Finally, construction of a rotating-stroke piston pump with several pistons running on one shaft is complex. Such a pump requires a plural number of pistons, corresponding to the number of lubricating points, that must be sealed and held in sliding bearings, as well as a corresponding plural number of feeders and seals on the sucking sides of each piston. In addition, the many working pistons with the associated friction increases the electric driving power that is required and can introduce undesired vibrations into the overall system.

### BRIEF DESCRIPTION OF THE INVENTION

The purpose of the present invention is therefore to provide a lubrication system for an escalator or a moving walk or a transportation system in which the individual lubrication points can be precisely and individually supplied with different quantities of lubricant.

This purpose is fulfilled by a lubricating system in which lubrication points are provided with lubrication through a lubricant pipeline having parallel feeders for each of the lubrication points. The pipeline is connected to a pump and includes a valve arrangement to selectively control each feeder.

According to the invention, a lubricating system for a transportation system, in particular an escalator or a moving walk, comprises a pump for delivery of a prescribed quantity of lubricant per work cycle and an arrangement of lubrication points with one or more lubrication points. A lubricant pipeline branches into parallel branches, each branch connecting the pump to a lubrication point of the lubrication point array. The lubricant feeders or individual branches can advantageously comprise fluid pipes, in particular flexible plastic pipes, and/or fluid passages, for example in components of the transportation system.

The pump is embodied as a piston pump, preferably as an electromagnetically actuated piston pump. By this means, in particular in contrast to the known vane-cell pumps and gear pumps, it is possible to measure out the quantity of lubricant that is transported in the lubricant pipeline very precisely and exactly. The quantity is a function of stroke, piston cross-sectional area, and number of work cycles. In an advantageous embodiment, the volume of lubricant displaced by the piston in one stroke is 30 to 120 mm³, preferably 50 to 90 mm³; especially preferable is essentially 60 mm³. The cycle time can then be essentially 1 working cycle per second. Preferably, the time distance between two work strokes is 0.5 to 5 seconds to pump sufficient lubricant and transport it to the lubrication points. Thus, through specification of the work cycles, the quantity of lubricant that is transported to the lubrication points can be very precisely and exactly measured out and easily varied in wide areas of application and use.

Further, according to the invention, the lubrication system comprises an arrangement of valves through which each branch of the lubrication pipeline can be selectively blocked or connected to the pump, i.e. opened. In a particularly preferred embodiment, for this purpose between the piston pump and each lubrication point of the lubrication point layout there is a respective controllable valve or electrovalve, in particular an electromagnetically operated valve, assigned to the valve arrangement in the branch of the lubricant pipeline that connects the pump and the respective lubrication point. By this means the targeted filling of the individual lubrication points with a precisely definable quantity of lubricant is possible. If when the valve is open, the piston pump transports to the assigned lubrication point a quantity of lubricant that is precisely prescribable by the number of cycles. On the other hand, other or additional lubrication points, whose assigned valves are closed, are not supplied with lubricant.

In an alternative embodiment the valve arrangement can also contain a switchover valve, in particular a switchover valve that is driven by electric motor, that selectively opens a branch or feeder, while the other branches or the other feeders are closed. For this purpose, for example, in a rotating or sliding switchover valve a moving member can be moved in such a manner that in each case a different branch is connected to the pressure side of the pump.

In principle, several branches or pipes that connect the pump to the lubrication points can be opened simultaneously while the pump transports lubricant. The entire transported quantity of lubricant then distributes itself over the respective lubrication in ratios according to the flow resistances in the individual feeders. Especially preferred, however, is that at the most only one branch or feeder is open so that the quantity of lubricant that is transported to the latter can be prescribed very precisely and exactly by the number of work cycles of the pump.

According to the invention it is thus possible, with a relatively low constructional outlay, to supply individual lubrication points with different quantities of lubricant. Through the arrangement of the valves the targeted filling of selected lubrication points is possible. The piston pump thereby allows the delivery of exactly prescribable quantities of lubricant to the prescribed lubrication points. Through changing the number of cycles, for example through corresponding control of the pump, the quantity of lubricant can be easily changed. For this purpose, a controller for the transportation system can, for example, transmit to a control device of the lubrication system the quantity of lubricant that is required at the respective lubrication points that can depend on the travel speed, the operating conditions (summer/winter, indoor/outdoor operation, traffic or passenger transportation, and the like). The control or control system of the lubrication system then changes the number of cycles of the pump accordingly.

Preferably, individual lubrication points can be successively supplied with lubricant, and advantageously the sequence be easily changed by changing the control of the valve arrangement. In particular, for example, individual lubrication points can be omitted in a targeted manner, which is particularly advantageous for the lubrication of individual chains, sliding surfaces of steps or step axles, or other moving parts or sliding surfaces, if they should be lubricated after a replacement, or on a first lubrication. The quantity of lubricant for individual lubricating points relative to each other can also be changed by the service man or service technician, in that the number of cycles of the pump relative to the lubrication points can be correspondingly changed when, for example, a handrail chain must be more intensively lubricated at new lubrication intervals due to changing operating conditions.

A lubrication system according to the invention can, for example by disabling valves or replacing or removing individual valves by means of pipeline closures and/or through changes of the pump control and in particular the number of cycles for the individual lubrication points, be easily adapted to different transportation systems. Thus, a universally and flexibly applicable lubrication system is therefore made available by the invention.

If, for example, in a basic embodiment a valve arrangement with five or seven controllable valves is provided, of which each one is assigned to a left or a right step chain, a left or a right drive chain, a handrail drive chain, or a left or a right handrail chain, by means of a dummy connection this lubrication system can be easily converted for use in a transportation system with no lubrication for the step, drive, and handrail chain. Equally, for example, only the valves for the handrail chains can be closed off or obviated. In the control of the pump, the number of work cycles for the closed-off branches or feeder lines is set or reset to zero.

Equally well, by increasing the number of cycles of the pump, the basic embodiment of the lubrication system can be adapted to, for example, an escalator or a moving walk or a transportation system with great travel height, higher speed of circulation, or larger chains or chain surface pressures.

In a preferred embodiment, the electromagnetically actuated piston pump and the electromagnetically actuated valves or the electromagnetically actuated switchover valve or the valve arrangement can be supplied with the same voltage, preferably with 12V, or up to 24V or 110V direct or alternating current. Thus, the entire lubrication system requires only one uniform voltage and can therefore be used very universally and worldwide. Advantageously, use of a low voltage may require no ducting of the electric cables and can thus further reduce the outlay for components and assembly.

The piston pump that in each case fills only selected lubrication points depending on the individually controlled valve arrangement increases the lubricating accuracy and the lubricant dosability of the lubricating system. This makes it possible to prevent, on the one hand, an underlubrication, and on the other hand overlubrication, which would cause damage to, or soiling of, the transportation system. Thus, the total quantity of lubricant that is used can be reduced, which can advantageously reduce the ecological burden on the environment by the lubricant that is consumed as well as the constructional volume of the lubrication system.

Preferably, the piston pump and the valve arrangement are accommodated in a common housing, enclosure, mounting support plate or installation plate that can be advantageously embodied on an encapsulated construction against splashing water, all weather conditions and/or can be impact resistant. This allows such pre-assembled lubrication systems to be universally and flexibly used for various transportation systems. On site, it is only necessary to fasten the housing, enclosure, mounting support plate, or installation plate, with the pump premounted therein, and with the valves premounted therein onto a truss of the transportation system, for example by welding, or bolting, or clipping on. Thereafter, only the valve outlets have to be connected to the individual lubrication points and the pump valve arrangement to an energy source. Advantageously for this purpose, at least part of a control unit for the pump can also be arranged or accommodated in the housing.

Control can take place autonomously, the quantities of lubrication for the individual lubrication points being settable on the control unit itself, and lubrication being initiated or started directly through the control unit. Equally, the control unit can also be connected with a control of the transportation system, and receive from the latter the required quantity of lubricant and the command to begin a lubrication.

In an advantageous embodiment, lubrication points are assigned to a step chain, to a drive chain, and/or to a handrail drive chain of the transportation system. These various chains require regular lubrication. Also here, because of the different requirements for lubricant, an individual filling with different quantities of lubricant is particularly advantageous. Equally however, other lubrication points can also be assigned to other sliding surfaces or moving parts. Thus, for example, a lubrication system according to the invention can also be combined with a lubrication system for lubricating the sliding surfaces of steps of an escalator, as is known from U.S. Pat. No. 6,471,033 B2, to whose entire contents in this respect reference is made.

One or more lubrication points or lubrication point arrangements to which the lubricant is directed can comprise one or more respective lubrication brushes and/or lubrication openings. Thus, with the lubrication system according to the invention, different lubrication points can be filled with different exactly prescribable quantities of lubricant. Advantageously, different lubrication points can also have a different number of lubrication brushes or lubrication openings. Thus, for example, two lubrication points that each have two lubrication openings for left and right step chains or pallet chains, two lubrication points that each have three lubrication points for left and a right drive chains, and a lubrication point with two lubrication openings for a handrail drive chain can be provided. In addition, two lubrication points that each have two lubrication openings for left and right handrail chains can be provided. It is advantageous for a total of 4 to 7 lubrication points, preferably 4 to 5 lubrication points, to be provided.

The pump can withdraw the lubricant from a stock or reservoir and dispose of surplus lubricant into a collection container. However, in a preferred embodiment, the lubrication system comprises a loop feeder into which a branch or feeder of the lubricant pipeline communicates with an inlet side of the pump so that lubricant that is transported by the pump into the lubricant pipeline but from there, on account of closed valves or flow resistance in individual branches or feeders, does not reach the lubrication points, is returned to the lubricant stock from which it is drawn by the pump. On the one hand, this can enable inspection of the sealing of the lubrication system as described in more detail below. In addition, for example on first lubrication, lubricant can be reused that was introduced to remove air from the system. This relieves the environmental load of the system.

A lubrication system can contain a lubricant reservoir that is arranged in the direction of transportation of the pump between the valve arrangement and the pump, so that the pump transports lubricant out of the reservoir to the valve arrangement. The reservoir is preferably fillable from outside. In an advantageous embodiment, the reservoir is accommodated together with the pump valve arrangement in the housing or enclosure, or on the mounting support plate or installation plate, which reduces the assembly steps or installation steps on site, in particular the connection of the pump to the reservoir. To adapt the lubrication system to different transportation systems, various reservoirs with different capacities can be provided that are preferably exchangeably arranged in the housing or enclosure, or on the mounting support plate or installation plate.

Embodied in the lubricant reservoir can be an air separator and/or a moisture separator to remove air that is trapped in the lubricant, in particular during the first lubrication, or moisture that accumulates in the lubricant that can, for example, penetrate into the system through lubrication openings.

Arranged in the lubricant pipeline of a preferred embodiment of the present invention is a pressure measurement device, for example a pressure switch. As will be described below, this allows a sealing verification of the system or a functional verification of the individual valves or valve arrangement. In addition, functional faults, in particular impermissibly high lubricant pressure, can be promptly detected. In case of such functional faults, the pump can be switched off and/or the valves or valve arrangement can be opened to prevent damage to the components or parts, especially of the pump or of the valves.

To prevent overloading of the lubricant pipe, the pump, or the valves, a pressure reduction valve or pressure minimization valve can be provided in the lubrication pipeline which, at a certain limit pressure or upon system overpressure, opens and then allows the lubricant to flow out of the lubricant pipeline into the reservoir.

Arranged in addition in the lubricant pipeline and/or the lubricant reservoir can also be a heating and/or a cooling apparatus. This can be embodied, for example, in the form of heating and/or cooling coils around which lubricant flows and which carry by a heat carrier or refrigerant that is preheated by means of an electric heating device or which flows through a heat exchanger or an air conditioning system. Thus, for example, in the case of cool operating conditions, as they occur in winter on outdoor escalators or moving walks, the lubricant can be heated before a lubrication, and its viscosity and lubricating capacity thereby improved. Equally well, in hot climatic regions or in summer, the lubricant can be pre-cooled to avoid it being too hot for lubrication. Advantageously, such cooling can also cool the lubricated components, in particular or primarily the piston pump.

During a lubrication, for each lubrication point of the lubrication point arrangement that should be lubricated, the corresponding branch or the corresponding feeder of the lubricant pipeline between the pump and the lubrication point is first opened by the valve arrangement in that, for example, the assigned controllable valve of the valve arrangement is opened in the branch or in the feeder of the lubricant pipeline between the pump and the lubrication point. The pump is then operated with a prescribed number of work cycles so that it transports a defined quantity of lubricant into the branch or into the feeder of the lubricant pipeline and to the lubrication point where it emerges from the lubrication opening, lubrication brush or lubrication point and lubricates a passing chain, a sliding area, or the like. Afterwards, the branch or pipeline is closed by the valve arrangement in that, for example, the controllable valve in the branch or pipeline is closed.

It is preferable that all lubrication points that should be lubricated during a lubrication be processed successively in sequence in the manner described above, so that always a precisely defined quantity of lubricant is delivered at the most to one branch or one pipeline and to the assigned lubrication point.

Lubrication is advantageously performed at regular intervals and/or according to need. If at different lubrication points different lubrication periods are appropriate, since for example some chains or transportation chains absorb more lubricant and are therefore lubricated less often, during a lubrication it is not necessary for all valves of the valve arrangement to be open at all times. Thus, for example, after replacing a chain, only the assigned valve can be opened to perform a first lubrication of the chain.

Advantageously, the transportation system is operated during a lubrication so that the components that are to be lubricated, in particular chains or sliding areas, wipe against the lubrication openings or lubrication brushes of the respective lubrication point, collect any exuding lubricant there, and carry it further into the transportation system. The quantity of lubricant that is delivered thus can also depend on the motion or speed of the components that are to be lubricated—the faster the components stroke the lubrication points, the more lubricant per unit of time must be made available by the pump. Conversely, on a so-called crawl, it is advantageous for there to be no lubrication or only a reduced flow, for example, half as much as normal. In addition, after a lubrication, a running-in time for the transportation system can be provided to ensure adequate penetration and distribution of the lubricant. This running-in time preferably has a duration of 15 minutes to 30-45 minutes.

Before the first or subsequent commissioning of an escalator or moving walk or transportation system, a first lubrication can be performed according to program. For this purpose, the pump is first operated with a closed valve arrangement until the pressure measuring device detects a sufficient pressure, at which time the pressure reducing valve in the lubricant pipeline is opened and lubricant is transported bubble-free which, for example, can be optically verified at a transparent point in the lubricant pipeline. Subsequently, the individual branches or the individual pipelines are opened by the valve arrangement, the pump being operated further for a prescribed number of work cycles or until air-free lubricant emerges from the individual lubrication points.

Before a lubrication it is preferable for the filled height of the reservoir to be inspected. For this purpose a floating switch, for example, can detect the quantity of lubricant that is present. Only if sufficient lubricant is present is a lubrication performed whereas otherwise, for example, a warning is issued and operation of the pump discontinued. By this means, empty running or an empty stroke of the pump can be avoided.

Advantageously, before the first branch or the first pipeline is opened by the valve arrangement, it can be verified whether sufficient pressure build-up takes place. For this purpose, all valves or outputs of the valve arrangement are closed and then the pump is operated with a prescribed number of work cycles. Use is made of the pressure measurement device to check whether the pressure in the lubricant pipeline increases. Only if the pressure increases as appropriate depending on the number of pump cycles, is a lubrication performed. Otherwise, for example, a corresponding warning is issued and the lubrication system turned off, since either the pump is defective, the lubrication system is not sealed or leaks, or a valve does is not closing completely. Should there be a sufficient build-up of pressure, one or more branches or pipelines can be opened by the valve arrangement to start a lubrication cycle.

In a preferred embodiment, for each lubrication point of the lubrication point arrangement at which a lubrication takes place, correct functioning of the assigned valve is verified. For this purpose, the pressure measurement device detects whether after opening the corresponding branch or the corresponding pipeline between the pump and the lubrication point by the valve arrangement the pressure in the lubricant pipeline of the pump increases. If the pressure increases, the valve has not opened, and a corresponding error message can he issued and the branch or the pipeline or the complete lubrication system turned off.

### BRIEF DESCRIPTION OF THE DRAWINGS

Further advantages, objectives, and characteristics of the invention can be understood from review of the following description of preferred exemplary embodiments, taken in conjunction with the annexed drawings, wherein:

FIG. 1 is a diagrammatical representation of a lubrication system according to a first embodiment of the present invention; and

FIG. 2 is a diagrammatical representation of a lubrication system according to a second embodiment of the present invention.

### DETAILED DESCRIPTION OF THE EMBODIMENT

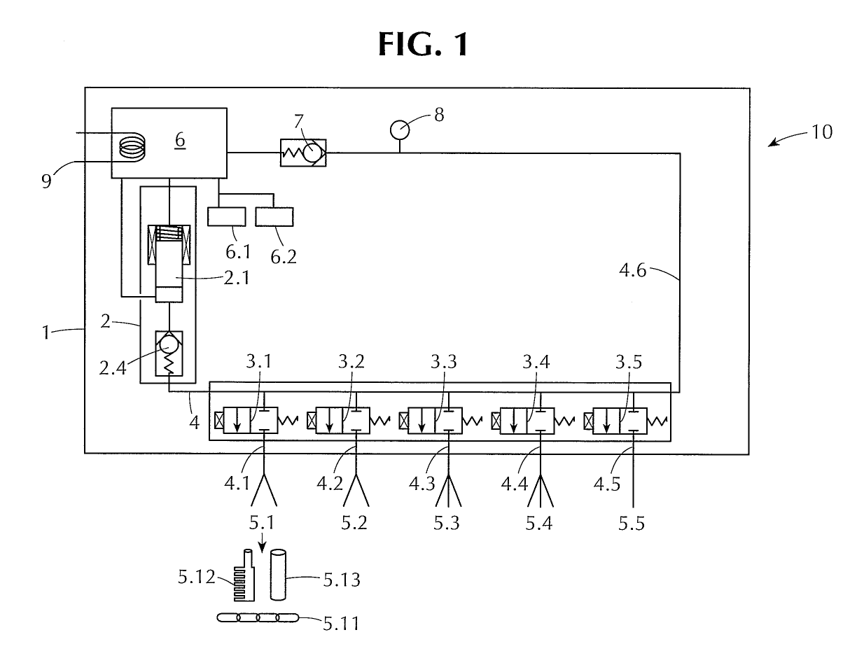

A lubrication system according to a first embodiment of the present invention is illustrated in FIG. 1 and comprises a mounting 1, such as a housing, an enclosure mounting support plate, or installation plate in or on which an electromagnetically operated piston pump 2 is accommodated. The pump comprises a movable piston 2.1 that is pushed by an electromagnet against the force of a compression spring. Arranged with the piston 2.1 is a spring-loaded check valve 2.4. The piston 2.1 presses the lubricant, which in the exemplary embodiment consists of lubricating oil or synthetic oil, from an inlet or sucking side to an outlet pressure side of the pump 2, the pressure side being connected to lubricant pipeline 4. The spring-loaded check valve 2.4 enables precise and exact dosing of the lubricant. In addition, by means of the spring-loaded check valve 2.4, backward flow of the lubricant out of the lubricant pipeline 4 is prevented. The precise and exact dosing is guaranteed or assured by the piston stroke against the spring-loaded check valve 2.4. The pressure level is held or maintained by the spring of the spring-loaded check valve 2.4 and allows a constant lubricant pressure.

If the piston 2.1 is pushed or moved or driven forwards by the electromagnets to the pressure side, the pressure of the lubricant that is enclosed therein increases, so that the check valve 2.4 opens and the lubricant flows into the lubricant pipeline 4. On deactivation of the electromagnets the piston pressure spring pushes the piston 2.1 to the sucking side. This allows new volume or lubricant to flow in. At the same time, the sucking side volume increases, as a result of which lubricant flows out of a reservoir 6 or lubricant container that is accommodated in the housing 1 or in the mounting support plate or in the installation plate.

Through the number of work cycles of the piston 2.1 the quantity of lubricant transported by the pump 2 can be very precisely and exactly prescribed since on each work cycle the volume displaced by the piston 2.1, which in a possible exemplary embodiment can be 60 mm³, is transported into the lubricant pipeline 4.

From the pressure connection to the pump 2, five parallel branches or five parallel pipelines 4.1 to 4.5 branch off from the lubrication pipeline 4, each to a lubrication point 5.1 to 5.5. The first lubrication point 5.1 may be assigned to a chain 5.11, such as a drive, handrail drive or right step or pallet chain 5.11 of an escalator (or moving walk) and may have for this purpose two lubricating brushes 5.12 or lubrication outputs 5.13 against which the right step chain or pallet chain wipes and thereby collects the lubricant or lubricating oil that exudes from the lubricating brush. The second lubrication point 5.2 is assigned to a left step chain of the escalator, and in similar manner has lubrication brushes against which the left step chain or pallet chain wipes. The third and fourth lubricating points 5.3 and 5.4 respectively are assigned to right and left drive chains of the escalator or of the moving walk and each may have three lubrication openings against which the right and left drive chain wipe and in doing so collect the lubricant or synthetic lubricating oil that exudes from the lubrication openings. Finally, the fifth lubrication point 5.5 may be assigned to a handrail drive chain and may have for this purpose one or two lubricating brushes against which the handrail drive chain wipes and collects exuding lubricant or lubricating oil.

Arranged in each of the five parallel branches or pipelines 4.1 to 4.5 is an electrically or electromagnetically actuated switching valve 3.1 to 3.5 in a valve arrangement 3 which in an unactuated or inactive state block, on application of a control voltage, opens the respective branch or the respective pipeline. The valves 3.1 to 3.5 are also arranged in or on the housing enclosure, mounting support plate or installation plate 1 and are each connected to the lubricant pipeline 4 via a flexible plastic tube or a flexible plastic hose that is itself connected to the pressure connection of the pump 2.

Additionally, in or on the mounting arranged in the housing or enclosure, which is embodied with splashing water encapsulation and in an impact resistant manner, is a control device (not shown) which controls the pump 2 and the valve arrangement 3 and performs a lubricating method that is described below. The control unit, the pump 2 and the valve arrangement 3 have an accessible connector for connection to an appropriate voltage source, which may be 12/24 volts, 110 volts or otherwise. Further, the control device may have a known type of connection for the exchange of data with a control unit for the escalator (not shown) or of the moving walk (not shown).

Through the arrangement of all-important components in or on the mounting 1, enclosure, the lubricating system can be largely pre-installed. On site, it is only necessary for the mounting 1 to be fastened to the escalator, the energy supply and the data exchange connections to be connected to an energy source and to the control unit of the escalator or of the moving walk, and the pressure side connections of the valves 3.1 to 3.5 to be connected to the corresponding lubrication points 5.1 to 5.5. For this purpose, the valves 3.1 to 3.5 and the lubrication points 5.1 to 5.5 are connected with flexible or rigid fluid pipelines or lubricant pipelines.

Parallel to the five branches or the five pipelines 4.1 to 4.5 that are connected to the respective lubrication points 5.1 to 5.5 the lubricant pipeline or fluid feeder has a sixth branch or return line 4.6 that connects the pressure side of the pump 2 to the reservoir 6 or lubricant container and returns surplus lubricant into the reservoir 6. Arranged in this sixth branch or return line 4.6 is a pressure reducing valve 7 and a pressure switch 8 which is connected to the control unit of the lubrication system and monitors the pressure of the lubricant in the lubricant pipeline 4 and in the sixth branch or return line 4.6.

Further, arranged in the reservoir or in the lubricant container 6 is a heating apparatus in the form of an electric heating coil 9 which is also connected to the 12V up to/or 24V or 110V or 220V to 240V voltage source and switched on and off or regulated by the control device. If the lubrication system has to be started under cold operating conditions, for example on an outdoor escalator or outdoor moving walk in winter, before and during the lubrication the heating apparatus 9 is activated and the lubricant or lubricating oil thus pre-warmed to improve its viscosity and lubricating capacity before it is transported by the pump 2. An air and/or moisture separator 6.1 and floating level switch 62 may also be associated or incorporated with the reservoir.

During commissioning or activating of the lubrication system, all controllable valves 3.1 to 3.5 of the valve arrangement 3 are first closed and the reservoir 6 filled with lubricating oil. Subsequently, the pump 2 is operated until the pressure switch 8 detects an appropriate operating pressure. The pressure reduction valve 7 opens only until the lubricant flows bubble-free in the lubricant pipeline 4, which can be verified through a sight glass or through transparent feeders (not shown) in the lubricant pipeline 4. To ensure freedom from bubbles or air, a further 40-60 work cycle of pump 2 is performed after the pressure switch 8 has detected the operating pressure. Subsequently, the valves 3.1 to 3.5 are opened in sequence and individually and the pump 2 operated with a prescribed or preset number of cycles so as also to completely fill the branches or the feeders 4.1 to 4.5 to the lubrication points 5.1 to 5.5. The number of cycles is determined either by calculation or empirically in such manner that filling of the individual branches or feeders is insured. Subsequently, several, preferably 3 to 12, normal lubricating cycles are executed so as to perform a first lubrication of the escalator or moving walk.

In a normal lubricating cycle it is first verified whether a sufficient build-up of pressure is present. For this purpose the pump 2 is operated with the valves 3.1 to 3.5 closed and the lubricant pressure in the lubricant pipeline 4 detected via the pressure switch 8. Should the pressure switch 8 not detect an increase in pressure corresponding to operation of the pump, an error message is issued and the lubricating system turned off, since it is assumed that pump 2 is defective and/or that one of the valves 3.1 to 3.5 or 3.7 is faulty or not completely closed, or that the lubricant pipeline 4 is leaky. If after, for example, 100 work cycles of the pump 2 the pressure detected by the pressure switch 8 exceeds a certain limit value, a faulty pressure build-up is recognized. If, on the other hand, a sufficient build-up of pressure is recognized, to relieve the pressure the valves 3.1 and 3.2 are briefly opened so that lubricant can flow out through the first and second branches and the feeders 4.1 and 4.2, respectively.

Subsequently, for each lubricating point in turn that is to be lubricated in the lubricating cycle a prescribed lubrication program or work cycle program is executed. In a particular lubricating cycle not all lubricating points need necessarily be lubricated. Since, however, the quantity of lubricant that is delivered to a lubrication point in one lubricating cycle can be very precisely and exactly prescribed by the number of work cycles of the piston pump 2, it is advantageous during every lubricating cycle to fill all lubrication points with a quantity of lubricant, however small, that ensures adequate lubrication of the respective chain of the escalator or moving walk until the next lubrication cycle.

First, the first valve 3.1 is opened while the other valves 3.2 to 3.5 or 3.7 remain closed. Subsequently, pump 2 is put into operation and executes a predetermined or prescribed number of work cycles. In doing so, it transports a certain quantity of lubricant that is displaced by the number of cycles and the volume displaced by the piston 2.1 through the first branch or the first feeder 4.1 to the first lubricating point 5.1 where it is collected by the right step chain (not shown) when it wipes against the two lubricating brushes or lubricating exits of the lubrication point. Subsequently, the valve 3.1 is closed. During this time the pressure switch 8 verifies whether a pressure in the lubricant pipeline 4 or in the sixth (return) branch 4.6 or in the lubricant pipeline 4 exceeds a predetermined limit value. Should such a pressure that exceeds the limit value be detected, it will be assumed that the valve 3.1 has faulted and not completely opened. An error message is issued and the system or the affected branch of the lubricating system turned off.

Subsequently, as described above for the first lubrication point 5.1, a prescribed lubricating program for the second to fifth lubrication points 5.2 to 5.5 is executed. At each lubrication point, an individual and precisely required or precisely dosable quantity of lubricant can be filled, in that with an opened valve the pump 2 executes a corresponding different number of work cycles.

Each time before the pump 2 is put into operation and/or during its operation the filled height in the reservoir or lubricant container 6 is detected by a floating switch (not shown). Should the filled height exceed a prescribed limit value or minimum filling level, the pump is stopped and the lubricating system turned off to prevent empty strokes or empty operation of the pump 2.

The commissioning, first lubrication, and/or normal lubrication cycles as described above can be performed manually, semi-automatically, time-interval controlled, or computer-controlled. When performed manually, the valves 3.1 to 3.5 of the valve arrangement 3 and the respectively transported quantity of lubricant and the corresponding number of work cycles of the pump 2 are prescribed manually. When performed semi-automatically, the process steps described above are executed by the control unit of the lubrication system after the lubrication system has been activated from the outside. The sequence of the lubrication points and the prescribed quantities of lubricant and the corresponding number of work cycles of the pump are permanently prescribed in a memory of the control device. When performed by computer control, the control unit of the lubrication system is instructed by the control of the escalator or of the moving walk to execute a commissioning, a first lubrication, or a normal lubrication cycle, as appropriate, the sequence of the lubrication points and the prescribed quantities of lubricant being stored in the control unit of the lubrication system. Further information about the operating conditions, for example the speed of circulation or the run-off speed of the chains, can be prescribed by the control of the escalator. Conversely, the control unit of the lubricating system can pass on to the control of the escalator error messages which the control issues and/or displays.

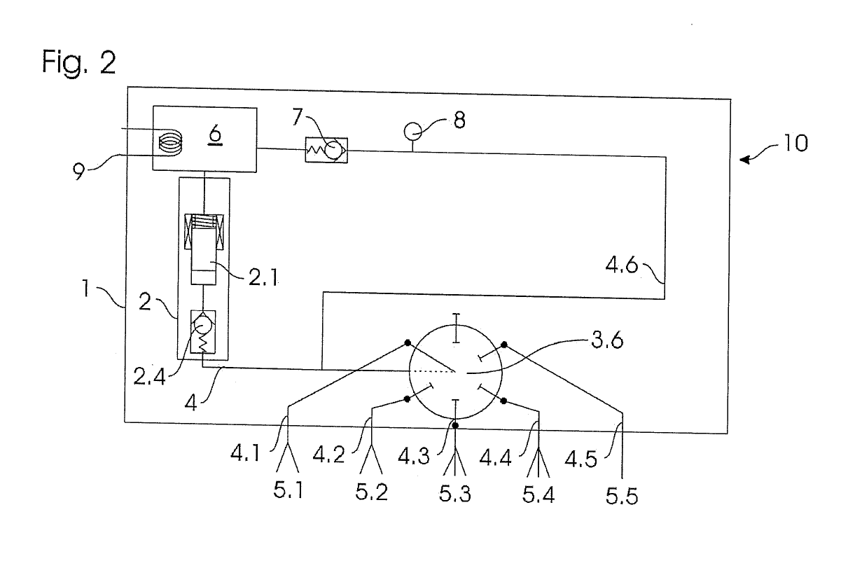

FIG. 2 shows a lubrication system according to a second embodiment of the present invention. Elements and characteristics that are identical to the first embodiment are referenced with the same reference numbers so that for their explanation reference can be made to the foregoing or above discussion.

The lubrication system according to the second embodiment is essentially identical in construction and function to the first embodiment described above by reference to FIG. 1. In contrast to the individual switching valves 3.1 to 3.5 or 3.7 that are respectively arranged in the branches or in the feeders 4.1 to 4.5 of the lubricant pipeline 4, however, the valve arrangement 3 in the second embodiment is embodied as a rotating switchover or rotating multi-way valve 3.6, which contains a rotatable element that, depending on its angular position or rotational position, connects one of the branches or feeders 4.1 to 4.5 of the lubrication pipeline 4 to the pressure side of the pump 2 or, when in a closed orientation, disconnects all branches or all feeders 4.1 to 4.5 from the pump 2.

In place of the successive or sequential and separate opening and closing of the individual valves 3.1 to 3.5 in the first embodiment, the rotating switchover valve 3.6 is switched by the control unit of the lubrication system by a motor, into a first to sixth position in which it connects the first, second, third, fourth, fifth, or none of the branches or feeders 4.1 to 4.5 of the lubricant pipeline 4 to the pressure side of the pump 2. The function or operation or work process is performed and processed as for the first embodiment. Thus, for example, should lubricant need to be transported to the first lubrication point 5.1, the rotating switchover valve 3.6 is brought or switched into the position shown in FIG. 2 in which the feeder 4.1 is connected to the pressure side of the pump 2 and the other branches or the other feeders 4.2 to 4.5 are blocked from the pump 2. If, on the other hand, pressure build-up is to be verified, the rotating switchover valve 3.6 is closed by further switching, for example by 60° in the clockwise direction. The pressure build-up can thereby be measured and verified by the pressure switch 8.

We claim:

1. A lubrication system for a transportation device, escalator or moving walk having a pump for delivering a prescribed or predetermined quantity of lubricant per work cycle, a lubrication point arrangement with at least one lubrication point, and a lubricant pipeline with at least one feeder connecting the pump in parallel to a lubrication point of the lubrication points arrangement,
characterized in that the pump is an electromagnetically actuated piston pump and that the lubrication system further contains a valve arrangement associated with the at least one feeder to selectively block and connect each feeder to the pump.

2. The lubricating system according to claim 1, further characterized in that the valve arrangement comprises a plurality of electromagnetically controllable valves, wherein a different one of said valves is located between the piston pump and each lubrication point in the feeder for the lubrication point.

3. The lubrication system according to claim 1 or 2, further characterized in that the piston pump and the valve arrangement (3) are accommodated on a common mounting.

4. The lubrication system according to claim 1 or 2, further characterized in that at least one of the lubrication points is associated with at least one of a drive chain and a handrail drive chain of a transportation system.

5. The lubrication system according to claim 1 or 2, further characterized in that the at least one lubrication point of the lubrication point arrangement comprises at least one lubrication brush or lubrication opening.

6. The lubrication system according to claim 1 or 2, further characterized in that the lubrication pipeline includes a return line communicating with a pressure side or a suction side of the pump.

7. The lubrication system according to claim 1 or 2, further characterized in that it includes a lubrication reservoir coupled to the pump.

8. The lubrication system according to claim 7, further characterized in that at least one of an air separator, moisture separator and floating switch is associated with the lubricant reservoir.

9. The lubrication system according to claim 1 or 2, further characterized in that a pressure switch pressure measurement device is arranged in the lubricant pipeline.

10. The lubrication system according to claim 1 or 2, further characterized in that arranged in at least one of the lubricant pipeline and a lubricant reservoir is a heating and/or cooling apparatus.

11. An escalator or moving walk transportation system with a lubrication system according to claim 1 or 2.

12. A method for operating a lubricating system according to claim 2, comprising the steps of:
a) connecting the pump and a lubrication point through the valve arrangement;
b) operating the pump with a prescribed number of work cycles;
c) separating the pump from the lubricating point through the valve arrangement; and
d) repeating steps a through c for another lubrication point.

13. The method according to claim 12, further including the following step for at least one lubrication point after the performance of step a:
a) checking whether the pressure in the lubrication pipeline increases.

14. The method according to claim 12 or 13, wherein before connecting the pump and a first lubrication point by means of the valve arrangement the following steps are performed:
a) closing the valve arrangement;
b) operating the pump with a prescribed number of work cycles; and
c) checking whether the pressure in the lubricant pipeline increases.

15. The method according to claim 12 or 13, wherein before the at operation of the pump the following step is performed:
a) verifying whether a sufficient stock of lubricant is present in a reservoir on a sucking side of the pump.
